(19) United States
(12) Patent Application Publication
(10) Pub. No.: US 2003/0050870 A1
(43) Pub. Date: Mar. 13, 2003

(54) Capacity-driven production planning tools

(76) Inventors: Brian D. Cargille, Palo Alto, CA (US); Gianpaolo Callioni, Palo Alto, CA (US); M. Eric Johnson, Hanover, NH (US)

Correspondence Address: HEWLETT-PACKARD COMPANY, Intellectual Property Administration, P.O. Box 272400, Fort Collins, CO, 80527-2400, US

(21) Appl. No.: 09/953,707

(22) Filed: Sep. 12, 2001

(51) Int. Cl. G06F 17/60

(52) U.S. Cl. 705/28

(57) ABSTRACT

The invention features production planning systems and methods that enable production planners to see how capacity decisions affect total production costs and understand the cost trade offs between excess capacity and inventory and, thereby, enable them to make appropriate manufacturing capacity level and inventory level decisions. In one aspect, a measure of manufacturing capacity is computed for a given product supplied by a manufacturing line producing one or more products and, based in part upon the computed manufacturing capacity measure, a safety stock level for the given product to cover uncertainty in demand over an exposure period with a target service level is computed. In another aspect, a measure of manufacturing cost is computed for a given product supplied by a manufacturing line producing one or more products based in part upon measures of manufacturing capacity for each of the one or more products produced by the manufacturing line; a measure of inventory driven cost for the given product is computed; and a total production cost for the given product is computed based upon the computed measures of manufacturing cost and inventory driven cost.

### CROSS-REFERENCE TO RELATED APPLICATIONS

This application is related to U.S. application Ser. No. ______, filed on even date herewith, by Brian D. Cargille et al., and entitled “Capacity-Driven Production Planning,” and to U.S. application Ser. No. ______, filed on even date herewith, by Brian D. Cargille et al., and entitled “Graphical User Interface for Capacity-Driven Production Planning Tool,” both of which are incorporated herein by reference.

### REFERENCE TO COMPUTER PROGRAM LISTING APPENDIX

This application includes a computer program listing appendix consisting of a Visual Basic® for Applications (VBA) computer program that is operable as a spreadsheet tool in the Microsoft® Excel application program for implementing a capacity-driven production planning tool. The computer program listing appendix is contained on a single compact disk (“Copy 1”; submitted herewith) as filename 10010888-1 (1).txt, which was created on Sep. 10, 2001, and has a size of 53,652 bytes. This file is compatible with the IBM-PC machine format and the Microsoft Windows operating system. An identical, duplicate copy of the computer program listing appendix is contained on a second compact disk (“Copy 2”; submitted herewith) as filename 10010888-1 (2).txt, which was created on Sep. 10, 2001, and has a size of 53,652 bytes. The entire contents of the attached compact disks are incorporated herein by reference.

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

This invention relates to systems and methods for capacity-driven production planning.

### BACKGROUND

Asset managers of large manufacturing enterprises, for example, computer manufacturers, electronics manufacturers and auto manufacturers, must determine the inventory levels of components and finished products that are needed to meet target end customer service levels (i.e., the fraction of customer orders that should be received by the requested delivery dates). For such manufacturing enterprises, the delivery of a finished product to an end customer typically involves a complex network of suppliers, fabrication sites, assembly locations, distribution centers and customer locations through which components and products flow. This network may be modeled as a supply chain that includes all significant entities participating in the transformation of raw materials or basic components into the finished products that ultimately are delivered to the end customer.

Each of the steps in a supply chain involves some uncertainty. For example, for a variety of reasons (e.g., changes in product life cycles, seasonal variations in demand, and changing economic conditions), future end customer demand is uncertain. In addition, the times at which ordered raw materials and components will be received from suppliers is uncertain. To handle such uncertainty, many different statistical production planning models have been proposed to optimize production at each level of a supply chain while meeting target service level requirements. In general, there are two different categories of production planning issues: (1) consumable resource (or inventory) planning issues (e.g., planning for finished goods, raw material, or work-in-progress in a manufacturing operation); and (2) reusable resource (or capacity) planning issues (e.g., planning for machine and labor usage in a manufacturing operation).

Master production scheduling (MPS) techniques typically are used by production planners to create manufacturing inventory planning models from which schedules for finished good supplies may be built. A planner may enter forecasted or actual demand requirements (i.e., the quantity of finished goods needed at particular times) into an MPS system. The MPS system then develops a schedule for replenishing the finished goods inventory through the production or procurement of batches of finished goods to meet the demand requirements.

Manufacturing capacity planning, on the other hand, involves a different set of modeling issues, including: (1) selecting tools for producing a particular product mix and volume; (2) selecting a product mix and volume that maximizes the value of an existing tool set; and (3) determining whether additional tools should be added to an existing tool set. Typically, capacity planning issues are addressed by mathematically modeling the manufacturing process. Such models may take the form of a simple spreadsheet, a detailed discrete event simulation, or a mathematical program, such as a linear or mixed integer program. Many capacity planning systems implement various versions of rough cut capacity planning techniques, which typically involve evaluating capacity constraints at some level between the factory and machine levels (e.g., at the production line level). In operation, a planner may enter into a rough cut capacity planning system a build schedule that may have been developed by a MPS system. The rough cut capacity planning system then determines whether sufficient resources exist to implement the build schedule. If not, the planner either must add additional capacity or develop a new build schedule using, for example, MPS techniques.

Typically, MPS and rough cut capacity scheduling procedures are repeated several times before a satisfactory build schedule (i.e., a build schedule that accommodates both inventory requirements and capacity constraints) is achieved. Once a satisfactory build schedule has been developed, the production requirements of the build schedule are supplied to a material requirements planning (MRP) system that develops a final schedule for producing finished goods. To arrive at a final production schedule, a planner may enter into the MRP system a number of production parameters, including production requirements of the build schedule, subassembly and raw materials inventory levels, bills of materials associated with the production of the finished goods and subassemblies, and information regarding production and material ordering lead times. The MRP system then produces a schedule for ordering raw materials and component parts, assembling raw materials and component parts into sub-assemblies, and assembling sub-assemblies into finished goods.

### SUMMARY

The invention features production planning systems and methods that enable production planners to see how capacity decisions affect total production costs and understand the cost trade offs between excess capacity and inventory and, thereby, enable them to make appropriate manufacturing capacity level and inventory level decisions.

In one aspect, the invention features a production planning method in accordance with which a measure of manufacturing capacity is computed for a given product supplied by a manufacturing line producing one or more products. Based in part upon the computed manufacturing capacity measure, a safety stock level for the given product to cover uncertainty in demand over an exposure period with a target service level is computed.

Embodiments in accordance with this aspect of the invention may include one or more of the following features.

The measure of manufacturing capacity may correspond to a measure of manufacturing line responsiveness. For example, the measure of manufacturing line responsiveness may comprise an estimated average manufacturing response time for the given product.

Measures of manufacturing capacity may be computed for each of the one or more products produced by the manufacturing line. The measures of manufacturing capacity may be computed based upon sets of production attributes for the one or more products. Each set of production attributes may comprise measures of line cycle time and average time between builds. The measures of manufacturing capacity for each of the one or more products may be computed based in part upon a measure of manufacturing line availability. The measure of manufacturing line availability may be computed based in part upon measures of shift length, number of shifts in a given unit of time, mean time line is inoperable, mean set-up time, set-up time variability, and production scheduling variability.

The safety stock level preferably is computed based upon measures of mean demand and demand uncertainty for the given product.

A measure of total cost of producing the given product also may be computed. The total cost measure may comprise measures of manufacturing cost and inventory driven cost for the given product. An optimal manufacturing capacity level and an optimal safety stock level for the given product may be estimated based upon one or more computed total cost measures. In some embodiments, the optimal manufacturing and safety stock levels are estimated based at least in part upon a stochastic simulation of one or more random variables.

In another aspect, the invention features a production planning method in which a measure of manufacturing cost is computed for a given product supplied by a manufacturing line producing one or more products based in part upon measures of manufacturing capacity for each of the one or more products produced by the manufacturing line; a measure of inventory driven cost for the given product is computed; and a total production cost for the given product is computed based upon the computed measures of manufacturing cost and inventory driven cost.

In another aspect of the invention, a production planning system includes a capacity calculation engine and an inventory calculation engine. The capacity calculation engine is configured to compute a measure of manufacturing capacity for a given product supplied by a manufacturing line producing one or more products. The inventory calculation engine is configured to compute a safety stock level for the given product to cover uncertainty in demand over an exposure period with a target service level based in part upon the computed manufacturing capacity measure.

In another aspect, the invention features a production planning system that comprises an inventory calculation engine. The inventory calculation engine is configured to compute a measure of manufacturing cost for a given product supplied by a manufacturing line producing one or more products based in part upon measures of manufacturing capacity for each of the one or more products produced by the manufacturing line. The inventory calculation engine also is configured to compute a measure of inventory driven cost for the given product. The inventory calculation engine is further configured to compute a total production cost for the given product based upon the computed measures of manufacturing cost and inventory driven cost.

Other features and advantages of the invention will become apparent from the following description, including the drawings and the claims.

### DESCRIPTION OF DRAWINGS

FIG. 1 is a block diagram of a distribution network that includes a factory that is configured to assemble finished goods from component parts that are received from a plurality of suppliers, and a distribution center that stores sufficient levels of finished goods inventory to cover uncertainty in end customer demand with a target service level.

FIG. 2 is a probability density plot of end customer demand for a product.

FIG. 3 is a diagrammatic view of factors that impact the levels of safety stock stored at the distribution center of FIG. 1.

FIG. 4 is a graph of production costs plotted as a function of the manufacturing excess capacity of the factory of FIG. 1 in a graphical representation of a production planning process.

FIG. 5A is a diagrammatic view of a process of deriving measures of manufacturing line responsiveness from sets of production and availability attributes for a manufacturing line of the factory of FIG. 1.

FIG. 5B is a diagrammatic view of a process of deriving inventory levels and production cost values for products produced by a manufacturing line based in part upon the manufacturing line responsiveness measures derived in accordance with the process of FIG. 5A.

FIG. 6A is a front view of a graphical user interface through which a production planner may interface with a production planning system.

FIG. 6B is a front view of a graphical user interface through which a production planner may input a set of manufacturing line production attributes for a product.

FIG. 6C is a front view of a graphical user interface through which a production planner may input a set of availability attributes for a manufacturing line of the factory of FIG. 1.

FIG. 7 is a flow diagram of a basic production planning simulation process.

FIG. 8 is a block diagram of an enterprise resource planning system.

### DETAILED DESCRIPTION

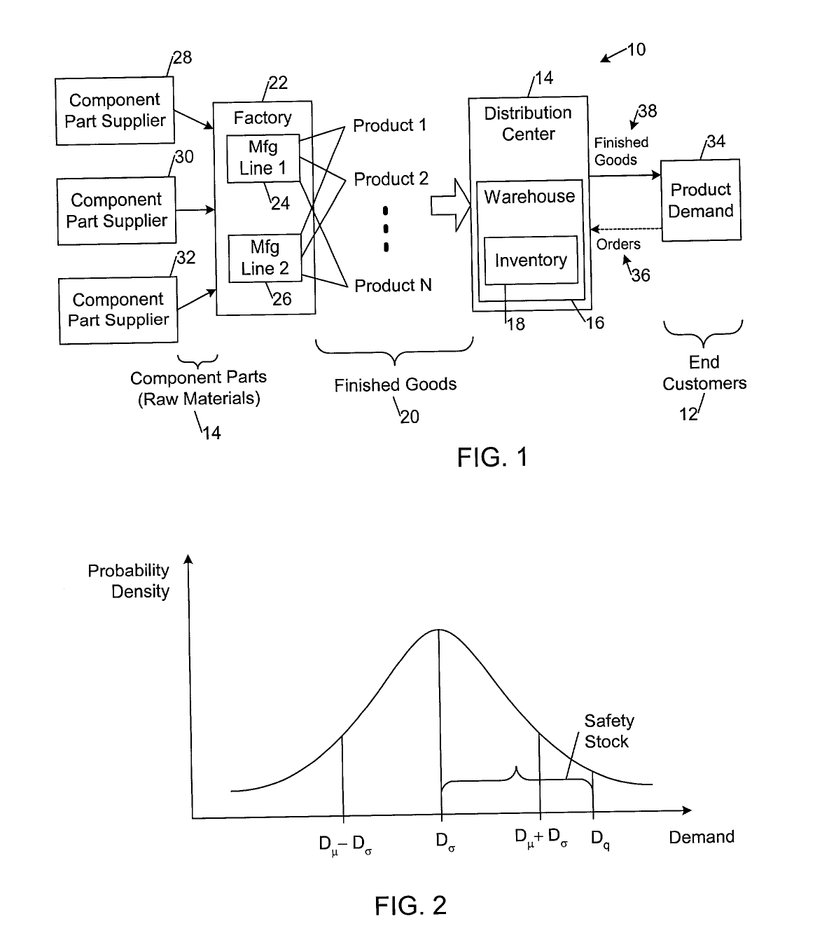

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale. Referring to FIG. 1, in one illustrative embodiment, a simplified distribution system 10 includes a network of end customers 12, and a distribution center 14 with a warehouse 16 that contains a product inventory 18. End customers 12 may include purchasers of branded retail products, purchasers of second label retail products, and direct sales purchasers. Product inventory 18 is replenished by shipments of finished goods 20 from a factory 22. Factory 22 includes a pair of manufacturing lines 24, 26 that are configured to assemble a plurality of products (Product 1 , Product 2, . . . , Product N) from component parts (or raw materials) that are supplied by a plurality of component part suppliers 28, 30, 32. In operation, end customer demand 34 drives orders 36, which are satisfied by shipments of products 38 from inventory 18. As explained in detail below, a production planner schedules the delivery of finished goods 20 so that the inventory levels at distribution center 14 are sufficient to cover both expected end customer demand and uncertainty in end customer demand. For purposes of discussion, inventory that is used to cover expected end customer demand considering replenishment frequency from the manufacturing line is referred to herein as “cycle stock,” and inventory that is used to cover uncertainty in end customer demand is referred to herein as “safety stock.”

Referring to FIG. 2, future end customer demand 34—which drives the flow of products through distribution system 10—typically is uncertain and may be modeled probabilistically as a probability density function that is plotted as a function of exposure period demand. Various demand forecasting techniques may be used to project future demand 20 by end customers 12 for finished goods 20. For example, future demand may be estimated based on a variety of information, such as experience, customer information, and general economic conditions. Alternatively, demand may be forecasted based upon an analysis of historical shipment data using known statistical techniques. No matter how demand is forecasted, however, the resulting demand forecast typically is characterized by a high level of uncertainty. Typically, future end customer demand 34 is estimated by a probability density function with a normal distribution that is characterized by an estimate of mean demand (D_{μ}) and an estimate of demand uncertainty (e.g., a standard deviation of D_{σ}).

As mentioned above, to protect against uncertainty in actual end customer demand (D_{q}), asset managers must keep a certain minimum inventory level (i.e., safety stock) on hand. In particular, the safety stock level is the amount of product that should be held in stock to cover the variability in demand over the uncertain exposure period in order to meet a target customer service level. The more safety stock that is maintained in warehouse 16, the greater demand variability that may be covered. Of course, if too much safety stock is kept on hand, any unused safety stock will increase product costs and decrease the profitability of the enterprise. As used herein, the service level that is achieved in a particular period is defined as the probability that the product demand in that period plus the unsatisfied product demand in previous periods is met.

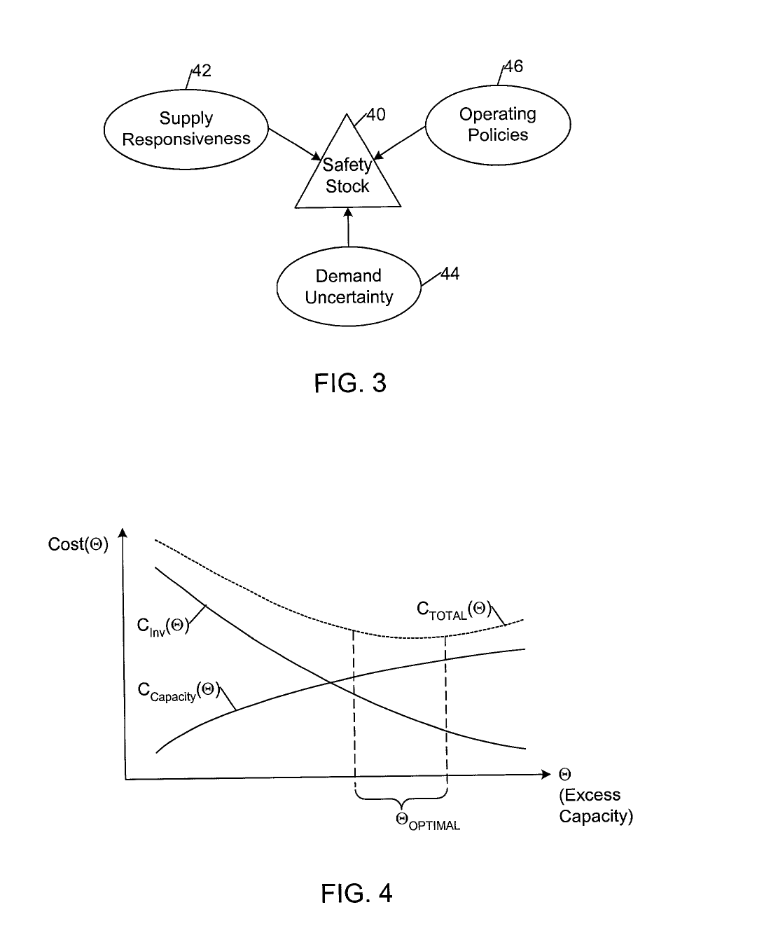

Referring to FIG. 3, from the perspective of the entire supply chain, several factors contribute significantly to the amount of safety stock that should be carried in warehouse 16. In particular, the level of safety stock is influenced significantly by the responsiveness of product supply 42 (e.g., mean replenishment time and replenishment time variability), the level of demand uncertainty 44, and the operating policies 46 selected for the operation of the enterprise (e.g., target service levels). As a general rule of thumb, additional safety stock should be carried when supply responsiveness is low or demand uncertainty is high, or both, and when the desired level of service is high. The inventors have realized, however, that uncertainty in end customer demand need not be buffered entirely with safety stock.

Indeed, excess end customer demand also may be buffered on the manufacturing side with excess manufacturing capacity. In particular, the responsiveness of product supply 42 may be increased by raising the level of excess manufacturing capacity to reduce the mean supply replenishment (or lead) time.

As shown diagrammatically in FIG. 4, inventory levels and, consequently, inventory cost (C_{INV}(Θ)) may be reduced as excess capacity (Θ) increases, while still covering uncertainty in excess demand in accordance with a target service level. Although manufacturing capacity cost (C_{CAPACITY}(Θ)) increases as excess capacity is increased, the drop in inventory-driven costs for a given increase in excess capacity may be significantly greater than the resulting increase in capacity costs. Thus, in many cases, a judicious selection of inventory and excess capacity levels may dramatically reduce the overall product production cost (C_{TOTAL}(Θ)=C_{INV}(Θ)+C_{CAPACITY}(Θ)). Indeed, it has been discovered that, in many cases, only a moderate increase in excess manufacturing capacity is needed to reduce total production costs significantly, especially in industries (e.g., the electronic an computer industries) where product life cycles are short and commodity prices erode quickly.

To capitalize on this insight, the inventors have developed a capacity-driven production planning tool (or system) that computes inventory levels and production costs for products produced on a manufacturing line based upon sets of manufacturing capacity data, demand data, and operating policy data. With this tool, production planners may see how capacity decisions affect total production costs and understand the cost trade offs between excess capacity and inventory and, thereby, make appropriate manufacturing capacity and inventory level decisions.

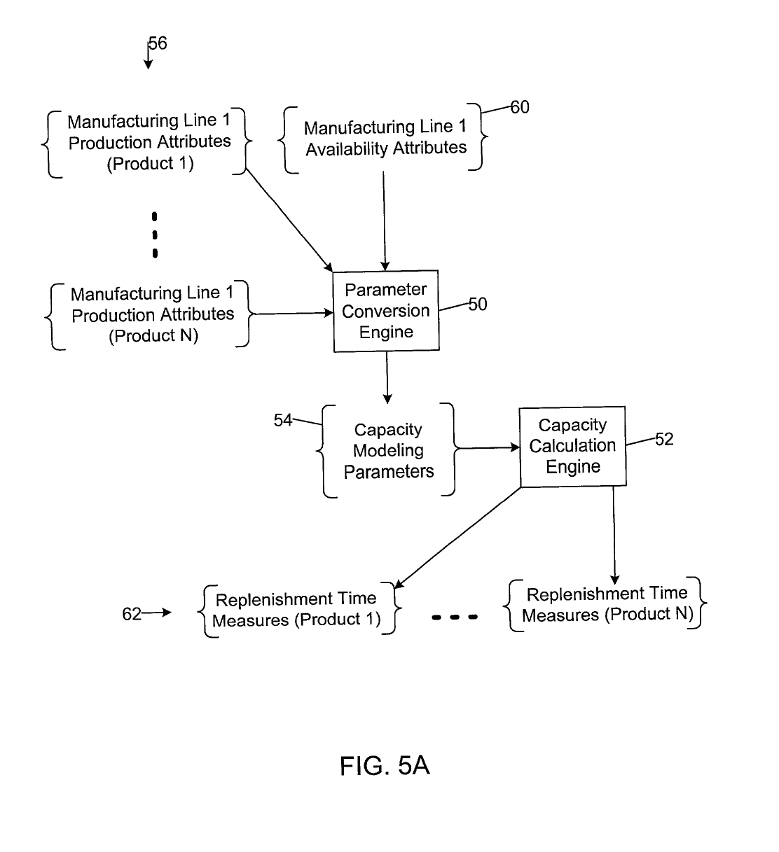

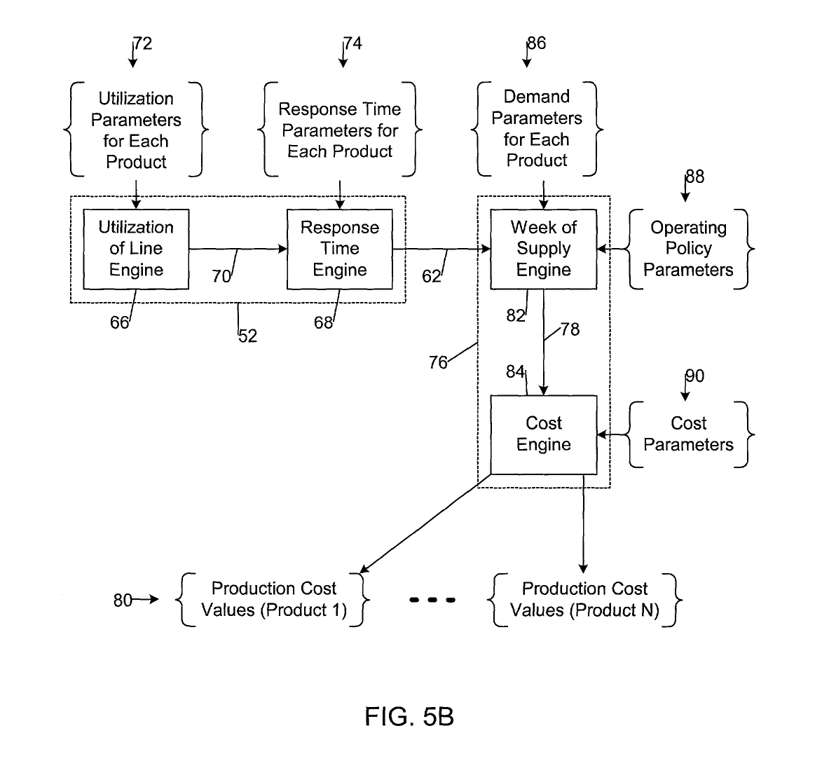

Referring to FIGS. 5A and 5B, in one embodiment, the production planning tool includes a parameter conversion engine 50 and a capacity calculation engine 52. Parameter conversion engine 50 is configured to derive a set 54 of capacity modeling parameters from sets 56 of production attributes for the products being manufactured on a manufacturing line and a set 60 of availability attributes for the same manufacturing line. Capacity calculation engine 52 is configured to compute measures 62 of the responsiveness of the manufacturing line from the set of capacity modeling parameters 54. In one embodiment, the capacity calculation engine 52 is configured to compute measures of the replenishment time and replenishment time variability for each product produced by the manufacturing line. As shown in FIG. 5B, capacity calculation engine 52 includes a utilization of line engine 66 and a response time engine 68. Utilization of line engine is configured to derive measures 70 of line utilization from a set 72 of utilization modeling parameters that are computed by parameter conversion engine 50. Response time engine 68 is configured to compute the measures 62 of manufacturing line responsiveness from the measures 70 of line utilization and from a set 74 of response time modeling parameters that are computed by parameter conversion engine 50 for each product that is produced on the manufacturing line.

The measures 62 of manufacturing line responsiveness are used by an inventory calculation engine 76 to compute inventory levels 78 and production costs 80 for products produced on the manufacturing line. Inventory calculation engine 76 includes a weeks of supply engine 82 and a cost engine 84. Weeks of supply engine 82 is configured to receive the manufacturing line responsiveness measures 62 and a set 86 of product demand modeling parameters and, based on this information, compute product inventory levels 78 that are sufficient to cover uncertainty in end customer demand with a service level specified by one or more operating policy parameters 88. Cost engine 84 is configured to compute the production cost values 80 based upon the computed product inventory levels 78 and a set 90 of cost parameters for the products produced on the manufacturing line.

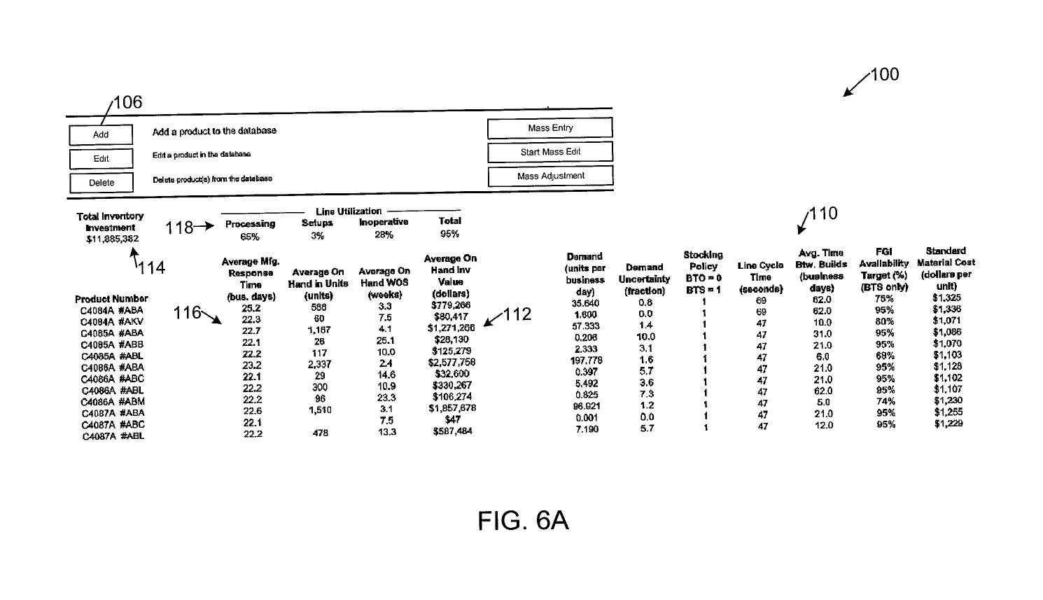

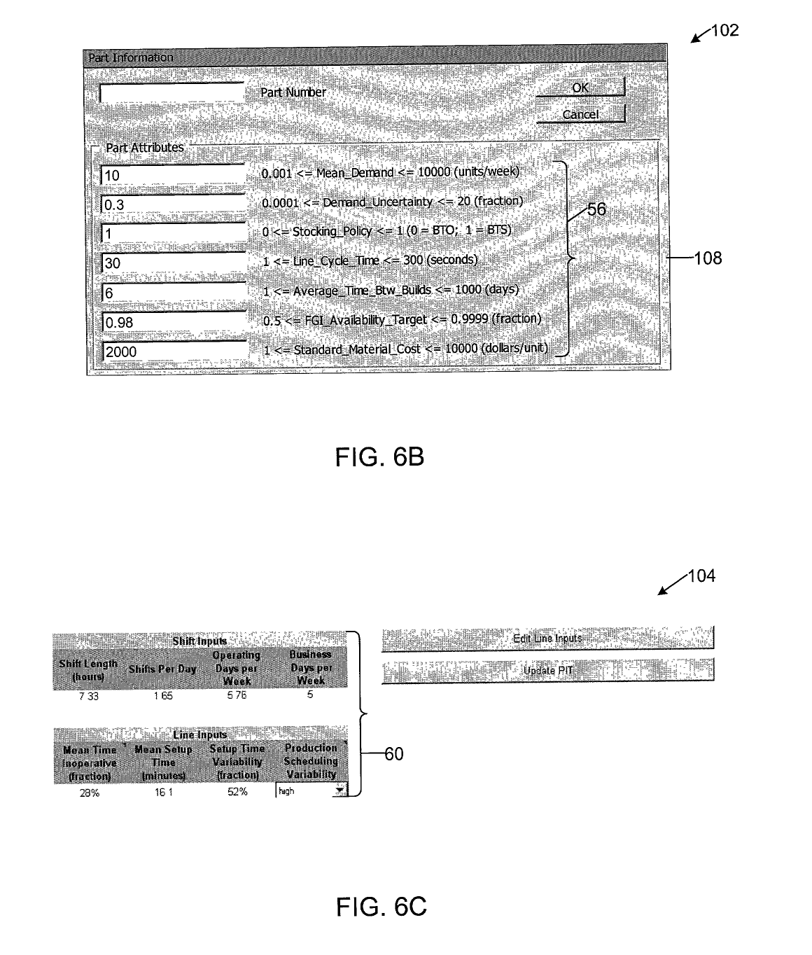

Referring to FIGS. 6A, 6B and 6C, the production attribute data 56 and the manufacturing line availability data 60 may be entered into the production planning system by a production planner through a set of graphical user interfaces 100, 102, 104. Graphical user interfaces 100-104 separate the presentation of information to a production planner from the underlying representation of calculations and interrelationships that are used by the production planning system to compute inventory levels and production costs for products produced on a manufacturing line. The graphical user interfaces 100-104 therefore free production planners from having to handle underlying references directly and, thereby, allow them to focus instead on the contexts and concepts of production planning.

The operation of the production planning system may be best understood with reference to the production parameter terms listed in the index of Appendix A and defined in the glossary of Appendix B. In general, the production parameters may be classified into the following categories: (1) product production input attributes 56; (2) manufacturing line availability input attributes 60; (3) product-specific production planning modeling parameters; (4) line-specific production planning modeling parameters; (5) inventory modeling parameters; (6) inventory output parameters; and (7) capacity output parameters. The product production input attributes 56 and the manufacturing line availability input attributes 60 are entered into the system by a production planner through graphical user interfaces 100-104. Based upon this information, the production planning system computes values for the remaining parameters and presents values for the inventory and capacity output parameters to the production planner through graphical user interface 100.

As shown in FIGS. 6A and 6B, in one embodiment, graphical user interface 100 enables a production planner to interact with the production planning system. For example, by activating an “Add” icon 106 that is presented by graphical user interface 100, a production planner may enter values for a prescribed set of production attributes for a product being produced on a given manufacturing line. In particular, upon activation of the Add icon 106, a product attribute dialog box 108 (FIG. 6B) opens prompting the production planner to enter values for a set of product production attributes 56. Among the product production attribute values that may be entered into the system for each product are: (1) product number; (2) mean demand; (3) demand uncertainty; (4) stocking policy (e.g., build to stock (BTS) or build to order (BTO)); (5) line cycle time; (6) average time between builds; (7) finished goods inventory (FGI) availability target; and (8) standard material cost. Each of these terms is defined in Appendix B. After values have been entered for each of these terms, they are displayed by graphical user interface 100 as a product attribute input data table 110 (FIG. 6A).

As shown in FIG. 6C, after production attributes 56 have been entered for each of the products produced by the manufacturing line, a production planner may enter through graphical user interface 104 values for a set of availability attributes 60 for the given manufacturing line. Among the availability attributes values that may be entered into the system for a given manufacturing line are: (1) shift length; (2) number of shifts per day; (3) number of production days per week; (4) number of business days per week; (5) mean time the line is inoperative; (5) mean set-up time; (6) set-up time variability; and (7) production scheduling variability. The mean time the line is inoperative is the fraction of available capacity that is consumed by non-productive activities, including maintenance, repairs, shortages, missing paperwork, and the like. The production scheduling variability depends at least in part upon the following factors: variability in scheduling practices; rescheduling due to parts shortages; expediting practices; set-up sequencing practices; and frequency of build to order production. Each of these terms is defined in Appendix B.

Referring back to FIG. 6A, in response to a request to update the system with new values that have been entered by a production planner, the production planning system presents sets of output data reflecting: (1) product-specific inventory investment information 112; (2) total inventory investment information 114; (3) product-specific manufacturing line capacity information 116; and (4) total line capacity information 118. The product-specific inventory investment information 112 includes the average number of units that are on hand for each product, the average number of weeks of supply (WOS) for each product, and the average value of on hand inventory for each product. The total inventory investment information 114 corresponds to the sum of the average values of on hand inventory for all products. The product-specific manufacturing line capacity information 116 corresponds to the average manufacturing response time for each product. The total line capacity information 118 reflects the total line utilization and the line utilization breakdown between processing time, set-up time, and down time.

Based upon the information presented by graphical user interface 100, production planners may see how capacity decisions affect total production costs and understand the cost trade offs between excess capacity and inventory and, thereby, make appropriate manufacturing capacity and inventory level decisions. Thus, a production planner may change one or more production attribute values (to see how such changes might impact overall production costs, including manufacturing and inventory-driven costs. In particular, a production planner may try to reduce overall production costs by increasing the level of excess capacity while reducing inventory levels. For example, a production planner may increase excess capacity by reducing one or more product production attributes, such as set-up time and set-up time variability, or adjusting one or more manufacturing line availability attributes (e.g., reduce down time or increase the number of shifts). In response to these new values, the production planning system will compute the inventory levels needed to cover uncertainties in end customer demand with the target service level. As mentioned above, in many cases, only a moderate increase in excess manufacturing capacity may be needed to reduce total production costs significantly, especially in industries (e.g., the electronic an computer industries) where product life cycles are short and commodity prices erode quickly. A production planner may run still other production scenarios through the production planning system in an effort to determine optimal capacity and inventory schedules under existing production conditions.

Additional details regarding the features and operation of graphical user interfaces 100-104 may be obtained from U.S. Pat. No. ______, filed on even date herewith, by Brian D. Cargille et al., and entitled “Graphical User Interface for Capacity-Driven Production Planning Tool.” Additional details regarding ways in which the production planning system may be used for production planning may be obtained from U.S. Pat. No. ______, filed on even date herewith, by Brian D. Cargille et al., and entitled “Capacity-Driven Production Planning.”

Other embodiments are within the scope of the claims.

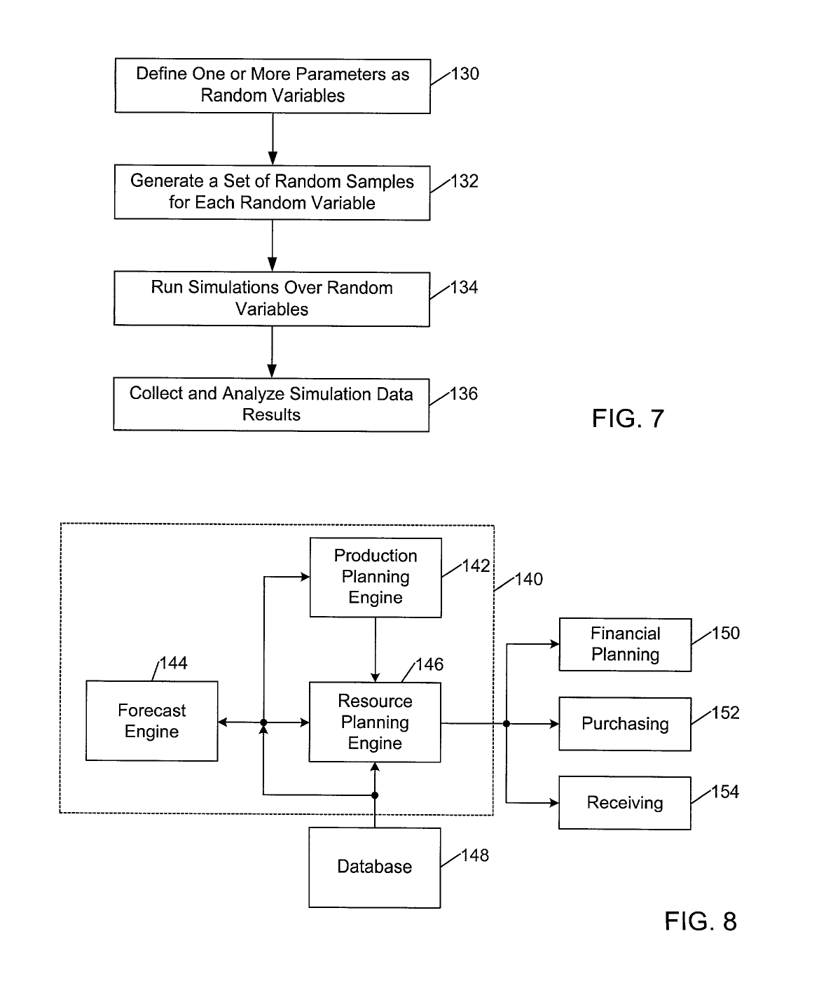

Referring to FIG. 7, the above-described production planning process may be extended by treating one or more input parameters (e.g., product production attributes, manufacturing line availability attributes, and operating policy parameters) stochastically. In accordance with another production planning embodiment, one or more input parameters are defined as random variables (step 130). A set of random samples for each random variable is generated (step 132). The sets of random samples may be generated based upon a selected probability distribution that matches an estimate of the mean and standard deviation for the random variable. Random samples are generated from the selected probability distribution using any one or several conventional techniques (e.g., the inverse transform method). Simulations (e.g., Monte Carlo simulations) are then run over the random variables (step 134). For information relating to Monte Carlo simulation techniques see, for example, PAUL BRATLEY ET AL., A GUIDE TO SIMULATION (1987) and JERRY BANKS ET AL., DISCRETE-EVENT SYSTEM SIMULATION (1996). The resulting data produced from the simulations is collected and analyzed statistically (step 136). This production planning process embodiment enables production planners to make statistically significant decisions relating to one or more of the input parameters and, therefore, make better production planning decisions.

As shown in FIG. 8, in another embodiment, the above-described production planning processes may be incorporated into an enterprise resource planning system 140 that is configured to estimate future on-hand inventory requirements and future replenishment requirements. Enterprise resource planning system 140 includes a production planning engine 142, a forecast engine 144, an enterprise resource planning engine 146, and a database 148. Production planning engine 142 is configured to implement the production planning processes described above based at least in part upon parameters supplied by a user or by forecast engine 144, or both. Forecast engine 144 is configured to analyze historical shipment data contained in database 148 and to compute an estimate of mean future demand 34 by end customers 12 for products 20, as well as compute an estimate of future demand variability. Enterprise resource planning engine 146 is configured to receive production planning information from production planning engine 142 and forecast information from forecast engine 144, and from this information estimate inventory levels at various distribution points in the supply chain using standard enterprise resource planning techniques. In particular, enterprise resource planning engine 146 may be operable to recursively compute replenishment requirements for a specific product at each distribution point. The distribution points may include warehouses, terminals or consignment stock at a distributor or a customer. Enterprise resource planning engine 146 may be configured to compute and set re-stock trigger points so that product may be shipped in time from the manufacturing facility to the distribution points. In one embodiment, enterprise resource planning engine 146 estimates distribution point inventory levels based upon information relating to the lead time needed to manufacture and transport product from the manufacturing facility to the distribution point. Information generated by enterprise resource planning system 140 may be transmitted to a financial planning unit 150, a purchasing unit 152 and a receiving unit 154 to carry out the resource planning recommendations of the system.

Although systems and methods have been described herein in connection with a particular computing environment, these systems and methods are not limited to any particular hardware or software configuration, but rather they may be implemented in any computing or processing environment, including in digital electronic circuitry or in computer hardware, firmware or software. In general, the component engines of the production planning system may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors include, for example, both general and special purpose microprocessors. Generally, a processor receives instructions and data from a read-only memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

Still other embodiments are within the scope of the claims.

[image]

[image]

[image]

[image]

[image]

[image]

[image]

[image]

[image]

[image]

[image]

[image]

[image]

[image]

[image]

What is claimed is:

1. A production planning method, comprising:
computing a measure of manufacturing capacity for a given product supplied by a manufacturing line producing one or more products; and
based in part upon the computed manufacturing capacity measure, computing a safety stock level for the given product to cover uncertainty in demand over an exposure period with a target service level.

2. The method of claim 1, wherein the measure of manufacturing capacity corresponds to a measure of manufacturing line responsiveness.

3. The method of claim 2, wherein the measure of manufacturing line responsiveness comprises an estimated average manufacturing response time for the given product.

4. The method of claim 1, further comprising computing measures of manufacturing capacity for each of the one or more products produced by the manufacturing line.

5. The method of claim 4, wherein the measures of manufacturing capacity are computed based upon sets of production attributes for the one or more products.

6. The method of claim 5, wherein each set of production attributes comprises measures of line cycle time and average time between builds.

7. The method of claim 4, wherein the measures of manufacturing capacity for each of the one or more products are computed based in part upon a measure of manufacturing line availability.

8. The method of claim 7, wherein the measure of manufacturing line availability is computed based in part upon measures of shift length, number of shifts in a given unit of time, mean time line is inoperable, mean set-up time, set-up time variability and production scheduling variability.

9. The method of claim 1, wherein the safety stock level is computed based upon measures of mean demand and demand uncertainty for the given product.

10. The method of claim 1, further comprising computing a measure of total cost of producing the given product.

11. The method of claim 10, wherein the total cost measure comprises measures of manufacturing cost and inventory driven cost for the given product.

12. The method of claim 10, further comprising estimating an optimal manufacturing capacity level and an optimal safety stock level for the given product based upon one or more computed total cost measures.

13. The method of claim 12, wherein the optimal manufacturing and safety stock levels are estimated based at least in part upon a stochastic simulation of one or more random variables.

14. A production planning method, comprising:
computing a measure of manufacturing cost for a given product supplied by a manufacturing line producing one or more products based in part upon measures of manufacturing capacity for each of the one or more products produced by the manufacturing line;
computing a measure of inventory driven cost for the given product; and
computing a total production cost for the given product based upon the computed measures of manufacturing cost and inventory driven cost.

15. The method of claim 14, further comprising computing measures of manufacturing capacity for each of the one or more products produced by the manufacturing line.

16. The method of claim 15, wherein the measures of manufacturing capacity are computed based upon sets of production attributes for the one or more products.

17. The method of claim 16, wherein each set of production attributes comprises measures of line cycle time and average time between builds.

18. The method of claim 14, wherein the measures of manufacturing capacity are computed based in part upon a measure of manufacturing line availability.

19. The method of claim 18, wherein the measure of manufacturing line availability is computed based in part upon measures of shift length, number of shifts in a given unit of time, mean time line is inoperable, mean set-up time, set-up time variability and production scheduling variability.

20. The method of claim 14, further comprising computing a safety stock level for the given product to cover uncertainty in demand over an exposure period with a target service level, and computing the inventory driven cost measure based in part upon the computed safety stock level.

21. A production planning system, comprising:
a capacity calculation engine configured to compute a measure of manufacturing capacity for a given product supplied by a manufacturing line producing one or more products; and
an inventory calculation engine configured to compute a safety stock level for the given product to cover uncertainty in demand over an exposure period with a target service level based in part upon the computed manufacturing capacity measure.

22. A production planning system, comprising an inventory calculation engine configured to:
compute a measure of manufacturing cost for a given product supplied by a manufacturing line producing one or more products based in part upon measures of manufacturing capacity for each of the one or more products produced by the manufacturing line;
compute a measure of inventory driven cost for the given product; and
compute a total production cost for the given product based upon the computed measures of manufacturing cost and inventory driven cost.

23. The system of claim 22, further comprising a capacity calculation engine configured to compute measures of manufacturing capacity for each of the one or more products produced by the manufacturing line.

24. The system of claim 23, wherein the measures of manufacturing capacity are computed based upon sets of production attributes for the one or more products.

25. The system of claim 23, wherein the measures of manufacturing capacity are computed based in part upon a measure of manufacturing line availability.
